(19) United States
(12) Patent Application Publication
(10) Pub. No.: US 2001/0016225 A1
(43) Pub. Date: Aug. 23, 2001

(54) Coating film forming apparatus and coating film forming method

(76) Inventors: Kunie Ogata, Tokyo (JP); Ryoichi Uemura, Kikuchi-gun (JP); Masanori Tateyama, Kikuchi-gun (JP); Toshihiko Nishigaki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/783,999

(22) Filed: Feb. 16, 2001

(30) Foreign Application Priority Data
Feb. 18, 2000 (JP) 2000-041196

(51) Int. Cl. B05D 3/12; B05C 11/08

(52) U.S. Cl. 427/10; 427/240; 118/712; 118/52

(57) ABSTRACT

A coating film forming apparatus comprising a coating solution supplying unit which supplies a coating solution to a rotating substrate, a memory which stores a first correlation between an atmospheric pressure and a film thickness of the coating film formed on the substrate, and a second correlation between a film thickness and a rotation speed of the substrate, an atmospheric pressure detector which detects an actual atmospheric pressure, a film thickness computation unit which computes an actual film thickness of the coating film from the actual atmospheric pressure based on the first correlation, and a rotation speed control unit which obtains a corrected rotation speed of the substrate based on the second correlation and a difference between the actual film thickness and a target film thickness, and rotate the substrate at the corrected rotation speed.

### CROSS-REFERENCE TO RELATED APPLICATIONS

This application is based upon and claims the benefit of priority from the prior Japanese Patent Application No. 2000-041196, filed Feb. 18, 2000, the entire contents of which are incorporated herein by reference.

### BACKGROUND OF THE INVENTION

The present invention relates to a coating film forming apparatus and a coating film forming method, for example, for coating a substrate with a resist film.

In the process of fabricating a semiconductor device on a semiconductor wafer (hereinafter referred to as a wafer), there is a successive process called photolithography in which a resist film is formed on the wafer, a circuit pattern or the like is reduced by photo-technology, and in which the resist film is exposed and developed.

In this photolithography process, as the circuit pattern becomes finer, it is more important to control the line width of the resist pattern precisely. The line width of the resist pattern like this changes according to various conditions such as conditions on the occasion of resist coating and the like.

For example, there is a spin coating method as one of methods for coating the wafer with a resist solution. In such a spin coating method, with an increase in the rotation speed of the wafer, centrifugal force becomes larger, and thus the film thickness becomes thinner, resulting in variations in line width. Specifically, the film thickness is influenced by the rotation speed of a motor of a spin chuck, and further changes depending on the temperature and humidity of an atmosphere. Therefore, hitherto, a resist film has been formed by the use of a test wafer, for example, every several days to decide a target value of the rotation speed of the motor capable of obtaining the optimum film thickness, and the atmosphere has been controlled to have a fixed temperature and a fixed humidity in a mass production process.

In spite of the aforesaid setting by an operator, however, ununiformity sometimes occurs to coating film thickness in mass production, and there is a possibility that this leads to defective line width of the resist pattern.

Even if a test and adjustment are performed regularly, when the film thickness is outside a specified value in mass production, it is required to stop the production line and repeat the test depending on its extent. In such a case, not only stable processing can not be performed, but also the frequency of tests is high, which becomes one of the causes of a drop in throughput.

### BRIEF SUMMARY OF THE INVENTION

An object of the present invention is to provide a coating film forming apparatus and a coating film forming method capable of controlling the line width of a resist pattern precisely.

According to a first aspect of the present invention, there is provided A coating film forming apparatus for forming a coating film on a substrate, comprising a rotating unit which rotates the substrate, a coating solution supplying unit which supplies a coating solution to the substrate rotated by the rotating unit, a memory which stores a first correlation between an atmospheric pressure and a film thickness of the coating film formed on the substrate and a second correlation between a film thickness and a rotation speed of the substrate, a target film thickness unit which generates a target film thickness of a coating film, an atmospheric pressure detector which detects an actual atmospheric pressure, a film thickness computation unit which computes an actual film thickness of the coating film from the actual atmospheric pressure detected by the atmospheric pressure detector based on the first correlation stored in the memory, and a rotation speed control unit which obtains a corrected rotation speed of the substrate based on the second correlation stored in the memory and a difference between the actual film thickness computed by the film thickness computation unit and the target film thickness, and controls the rotating unit to rotate the substrate at the corrected rotation speed.

According to a second aspect of the present invention, there is provided a coating film forming method for forming a coating film on a substrate, comprising rotating the substrate, supplying a coating solution to the rotating substrate, storing a first correlation between an atmospheric pressure and a film thickness of the coating film formed on the substrate and a second correlation between a film thickness and a rotation speed of the substrate in a memory, generating a target film thickness of a coating film, detecting an actual atmospheric pressure, computing an actual film thickness of the coating film from the actual atmospheric pressure detected in the atmospheric pressure detecting step based on the first correlation stored in the memory, and obtaining a corrected rotation speed of the substrate based on the second correlation stored in the memory and a difference between the actual film thickness computed in the computing step and the target film thickness, and rotating the substrate at the corrected rotation speed.

The present invention is based on new knowledge of inventors that the reason why the thickness of a coating film is not stable in spite of various settings is that the evaporation rate of a solvent or the like contained in the coating film is not stable under the influence of atmospheric pressure, and designed to find a film thickness at the atmospheric pressure and control the rotation speed of the substrate so as to eliminate a difference between the film thickness and the target film thickness.

Moreover, according to the present invention, an atmospheric pressure is once converted into a film thickness, and the rotation speed of the substrate holder is corrected to a correction rotation speed corresponding to a difference between this film thickness and the target film thickness. Generally, it is thought that the relation between film thickness and the rotation speed of the holder is liner and hardly influenced by atmospheric pressure, and hence by once converting into the film thickness as above, the structure of the apparatus is simplified, and the rotation speed can be corrected promptly.

Incidentally, it is preferable that the aforesaid coating film forming apparatus further comprise a film thickness detecting unit which detects an actual film thickness of a coating film formed on a substrate for imposing conditions, and a correlation storing unit which derives the correlation between atmospheric pressure and film thickness from the actual film thickness and an atmospheric pressure at that time, and stores this correlation in the first memory.

According to such a configuration, a film thickness is actually detected by using the substrate for imposing the process conditions every time the coating film forming conditions change, whereby the correlation between atmospheric pressure and film thickness can be obtained.

Furthermore, it is preferable that the coating film forming apparatus further comprise a correlation model storing unit which stores a model of the correlation between atmospheric pressure and film thickness, and that the correlation storing unit finds the correlation between atmospheric pressure and film thickness by applying the actual film thickness detected by the film thickness detecting unit and the atmospheric pressure at that time to the correlation model.

According to such a configuration, the use of the correlation model makes it possible to easily find the correlation between atmospheric pressure and film thickness, which simplifies the structure of the apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a plan view of a coating and developing processing system including a resist coating unit according to an embodiment of the present invention;

FIG. 2 is a front view of the coating and developing processing system in FIG. 1;

FIG. 3 is a rear view of the coating and developing processing system in FIG. 1;

FIG. 4 is a front view of a peripheral edge exposure unit shown in FIG. 1;

FIG. 5 is a plan view of the peripheral edge exposure unit in FIG. 4;

FIG. 6A to FIG. 6D are schematic plan views showing states in which a wafer is carried out of the peripheral edge exposure unit shown in FIG. 4 and FIG. 5;

FIG. 7 is a schematic block diagram showing the resist coating unit and a control system according to an embodiment of the present invention;

FIG. 8 is a diagram showing an example of a correlation model between atmospheric pressure and film thickness;

FIG. 9 is a diagram showing an example of a correlation between atmospheric pressure and film thickness;

FIG. 10 is a flowchart showing a condition imposing process;

FIG. 11 is a flowchart showing a product fabricating process;

FIG. 12 is a diagram showing a correlation between film thickness and rotation speed;

FIG. 13 is a diagram showing an application example to the correlation between film thickness and rotational speed;

FIG. 14 is a plan view of a coating and developing processing system according to another embodiment of the present invention; and

FIG. 15 is a perspective view of the interior of a clean room according to still another embodiment of the present invention.

### DETAILED DESCRIPTION OF THE INVENTION

An embodiment of the present invention will be explained below with reference to the drawings.

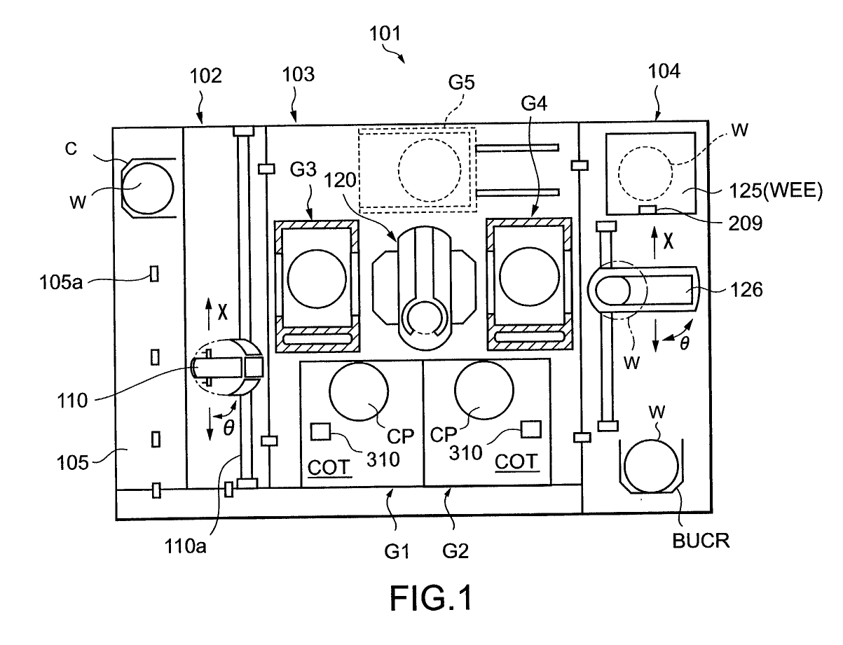

As shown in FIG. 1, this coating and developing processing system 101 comprises a cassette station 102 which transfers a plurality of, for example, 25 wafers W per cassette C, as a unit, from/to the outside into/from the coating and developing processing system 101 and carries the wafer W into/out of the cassette C, a processing station 103 in which various kinds of processing units each which perform predetermined processing for the wafers W one by one in a coating and developing process and are stacked in multiple stages, and an interface section 104 which receives and sends the wafer W from/to an aligner (not illustrated) provided adjacent to the processing station 103 are integrally connected.

In the cassette station 102, a plurality of, for example, four cassettes C are mounted in a line in an X-direction (in a top-to-bottom direction in FIG. 1) at the positions of positioning projections 105a on a cassette mounting table 105 as a mounting portion with respective transfer ports for the wafer W facing the processing station 103 side. A wafer carrier 110 movable in the direction of arrangement of the cassettes C (the X-direction) and in the direction of arrangement of the wafers W housed in the cassette C (a Z-direction, i.e., vertical direction) can freely move along a transfer path 110a and selectively get access to each of the cassettes C.

This wafer carrier 110 is also structured to be rotatable in a θ-direction so as to get access to an alignment unit (ALIM) and an extension unit (EXT) included in a multi-stage unit section of a third processing unit group G3 on the processing station 103 side as will be described later.

In the processing station 103, a main transfer device 120 is disposed in its central portion, and around the main transfer device 120, various processing units are stacked in multiple stages to compose one or a plurality of processing unit groups. In this coating and developing processing system 101, five processing unit groups G1, G2, G3, G4 and G5 can be disposed. The first and second processing unit groups G1 and G2 are disposed on the front side of the coating and developing processing system 101. The third processing unit group G3 is disposed adjacent to the cassette station 102. The fourth processing unit group G4 is disposed adjacent to the interface section 104. The fifth processing unit group G5 shown by a broken line is disposed on the rear side.

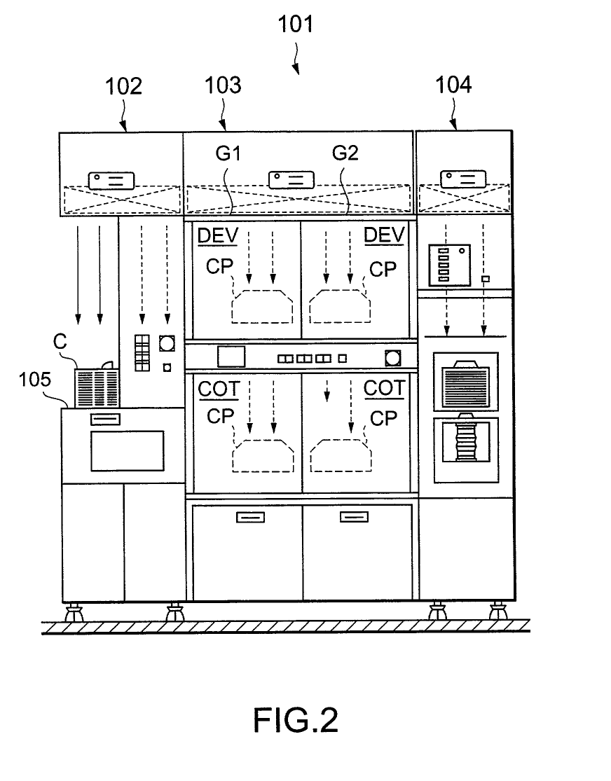

In the first processing unit group G1, as shown in FIG. 2, two spinner-type processing units which perform predetermined processing while the wafer W is mounted on a spin chuck within a cup 31 (CP), for example, a resist coating unit (COT) and a developing processing unit (DEV) are stacked in two-stages from the bottom in order. Similarly to the first processing unit group G1, in the second processing unit group G2, two spinner-type processing units, for example, a resist coating unit (COT) and a developing processing unit (DEV) are stacked in two-stages from the bottom in order.

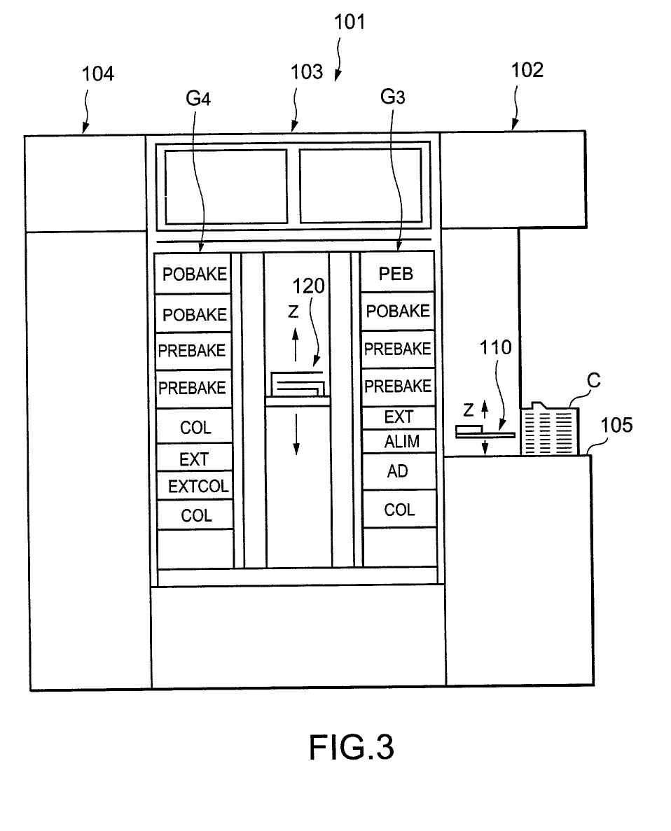

In the third processing unit group G3, as shown in FIG. 3, for example, a cooling processing unit (COL) which performs cooling processing, an adhesion processing unit (AD) which enhances the adhesion of a resist and the wafer W, an alignment unit (ALIM) which aligns the wafer W, an extension unit (EXT) which makes the wafer W wait, pre-baking units (PREBAKE), a post-baking unit (POBAKE), a post-exposure baking unit (PEB) which performs heating processing, or the like are stacked in eight-stages from the bottom in order.

In the fourth processing unit group G4, as shown in FIG. 3, for example, a cooling unit (COL), an extension and cooling unit (EXTCOL) which is a wafer carrying in/out section provided with a chill plate, an extension unit (EXT), a cooling unit (COL), pre-baking units (PREBAKE), post-baking units (POBAKE), or the like are stacked in eight-stages from the bottom in order.

In the interface section 104, as shown in FIG. 1, a peripheral edge exposure unit 125 is provided in its rear portion and a wafer carrier 126 is provided in its central portion. This wafer carrier 126 is structured to be movable in the X-direction and the Z-direction (the vertical direction) and rotatable in the θ-direction, and to be able to get access to the extension unit (EXT) included in the fourth processing unit group G4 on the processing station 103 side and a wafer delivery table (not illustrated) on the aligner (not illustrated) side.

Next, a processing process in the coating and developing processing system 101 structured as above will be explained.

In the coating and developing processing system 101, the unprocessed wafer W housed in the cassette C is taken out by the wafer carrier 110 in the cassette station 102, thereafter carried into the alignment unit (ALIM) of the third processing unit group G3 in the processing station 103 and aligned. Then, the main transfer device 120 is carried in from the opposite side, and the wafer W is carried out of the alignment unit (ALIM) and transferred. The wafer W is subjected to hydrophobic processing in the adhesion processing unit (AD) of the third processing unit G3 and cooled in the cooling processing unit (COL) of the third processing unit group G3 or the fourth processing unit group G4, and thereafter a photo-resist film, that is, a photosensitive film is formed by coating in the resist coating unit (COT) of the first processing unit group G1 or the second processing unit group.

After the photosensitive film is formed, the wafer W is subjected to heating processing in the pre-baking unit (PREBAKE) of the third processing unit group G3 or the fourth processing unit group G4, and a remaining solvent is removed by evaporation from the photosensitive film on the wafer W. After cooled in the extension and cooling unit (EXTCOL) of the fourth processing unit group G4, the wafer W is mounted in the extension unit (EXT) of the fourth processing unit group G4. Then, the wafer carrier 126 is carried in from the opposite side, and the wafer w is carried out.

The wafer W carried out is housed in a buffer cassette (BUCR) sequentially by the wafer carrier 126 which has received the wafer W. Thereafter, when a receiving signal is given by the aligner not illustrated, the wafer housed in the buffer cassette (BUCR) is delivered to the aligner by the wafer carrier 126 sequentially. After exposure by this aligner is completed, the exposed wafer is received again by the wafer carrier 126, and the peripheral edge portion of the wafer, for example, with a width of 2 mm is subjected to peripheral edge exposure processing in the peripheral edge exposure unit (WEE).

The wafer W subjected to the peripheral edge exposure processing is delivered to the main transfer device 120 via the fourth processing unit group G4 by a route reverse to the above and delivered to the post-exposure baking unit (PEB) by this main transfer device 120. The wafer W undergoes heating processing there, and then undergoes cooling processing to a predetermined temperature in the cooling processing unit (COL).

The wafer W is then delivered to the main transfer device 120, carried into the developing processing unit (DEV) of the first processing unit group G1 or the second processing unit group G2, and developed with a developing solution, and then the developing solution is rinsed away with a rinse solution, and thus developing processing is completed.

Thereafter, the wafer w is carried out of the developing processing unit (DEV) by the main transfer device 120. The wafer W is subjected to heating processing in the post-baking unit (POBAKE) of the third processing unit group G3 or the fourth processing unit group G4, and mounted in the extension unit in the third processing unit group G3. Then, the wafer carrier 110 is carried in from the opposite side, and the wafer W is carried out. The wafer W is carried into the cassette C for housing processed wafers mounted in the cassette station 102.

In the present invention, in the coating and developing processing system 101 explained above, as shown in FIG. 1, especially a film thickness measuring device 209 which detects the film thickness of a coating film formed on the wafer W for imposing process conditions is provided in the peripheral edge exposure unit 125 (WEE) and an atmospheric pressure meter 310 which detects the atmospheric pressure is provided in the resist coating unit (COT).

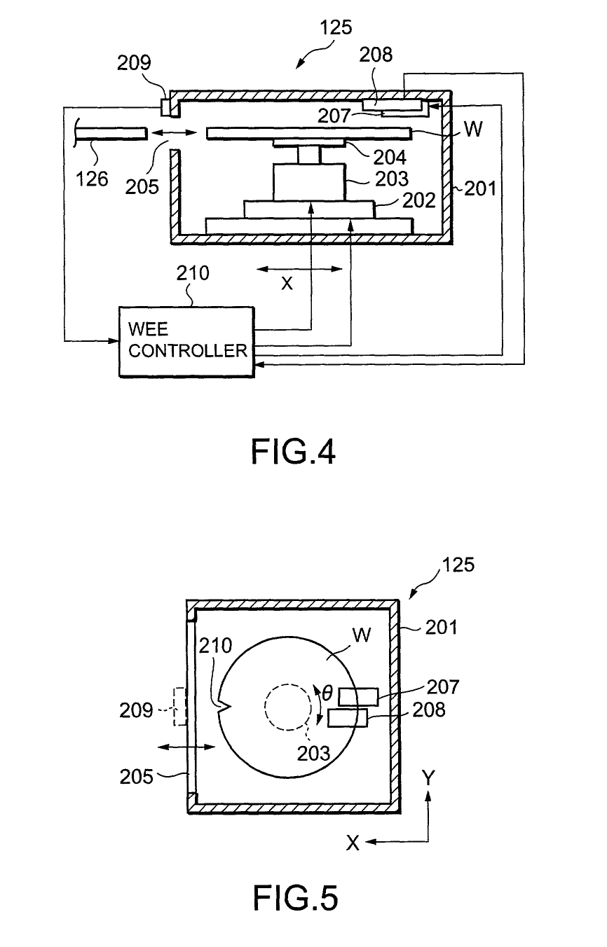

In FIG. 4 and FIG. 5, an X-Y stage 202 is disposed at the bottom of the casing 201 of the peripheral edge exposure unit 125. A rotating mechanism 203 is disposed on the X-Y stage. This rotating mechanism 203 is rotatably holds a spin chuck 204 for holding the wafer W. The wafer W is vacuum-sucked onto the spin chuck 204, for example, by a vacuum suction mechanism (not illustrated). Thereby, the wafer W is movable in the X- and the Y-direction and rotatable in the θ-direction inside the peripheral edge exposure unit 125.

An opening 205 for delivering the wafer W between the wafer carrier 126 and the spin chuck 204 inside the casing 201 is provided in a front face (a face opposite to the wafer carrier 126) of the casing 201. The width of the opening 205 is greater than the diameter of the wafer W, and the height of the opening 205 is greater than the total height when the wafer W is mounted on the wafer carrier 126.

An exposure mechanism 207 which performs preliminary exposure processing for a peripheral portion of the wafer W is disposed at a rear portion (the rear side as seen from the face opposite to the wafer carrier 126) of the ceiling of the casing 201. A sensor 208 which detects the position of the wafer W is disposed adjacent to the exposure mechanism 207. The film thickness measuring device 209, for example, of a light interference type which measures the film thickness of a resist film on the wafer W is disposed above the opening 205 on the outer side of the casing 201.

The result of an image picked up by the sensor 208 and the result of a film thickness measured by the film thickness measuring device 209 are sent to a WEE controller 210. The controller 210 controls the X-Y stage 202, the rotating mechanism 203, the exposure mechanism 207, and the like based on the image result and the like.

In the peripheral edge exposure unit 125 thus structured, when the wafer W is delivered from the wafer carrier 126 onto the spin chuck 204, the positions of the outer periphery of the wafer W and the exposure mechanism 207 are adjusted by moving the X-Y stage 202 and rotating the wafer W while the sensor 208 detects the position of the outer periphery of the wafer W. The exposure mechanism 207 and the edge of the wafer W are always aligned exactly by detecting the position (of the edge portion of the outer periphery of the wafer W) without positioning.

The vicinity of the entire outer periphery of the wafer W is preliminarily exposed by rotating the wafer W by the rotating mechanism 203 while irradiating a beam to the peripheral portion of the wafer W by the exposure mechanism 207.

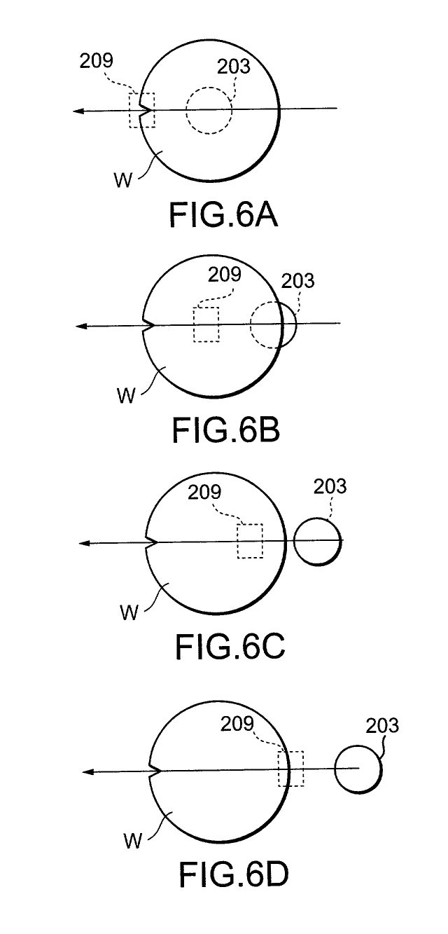

Moreover, on the occasion of the measurement of the film thickness of the resist film on the wafer W, after the wafer W is positioned as described above, as shown in FIG. 6A to FIG. 6D, the film thickness measuring device 209 measures the film thickness of the film on the wafer W while the wafer carrier 126, for example, a wafer holder of a transfer arm receives the wafer W from above the spin chuck 204 and carries the wafer W to the outside of the casing 201 through the opening 205. Without limiting to this case, there is a method in which the film thickness measuring device 209 is disposed inside the peripheral edge exposure unit 125 and in which the top face of the wafer W is scanned by a moving mechanism not illustrated.

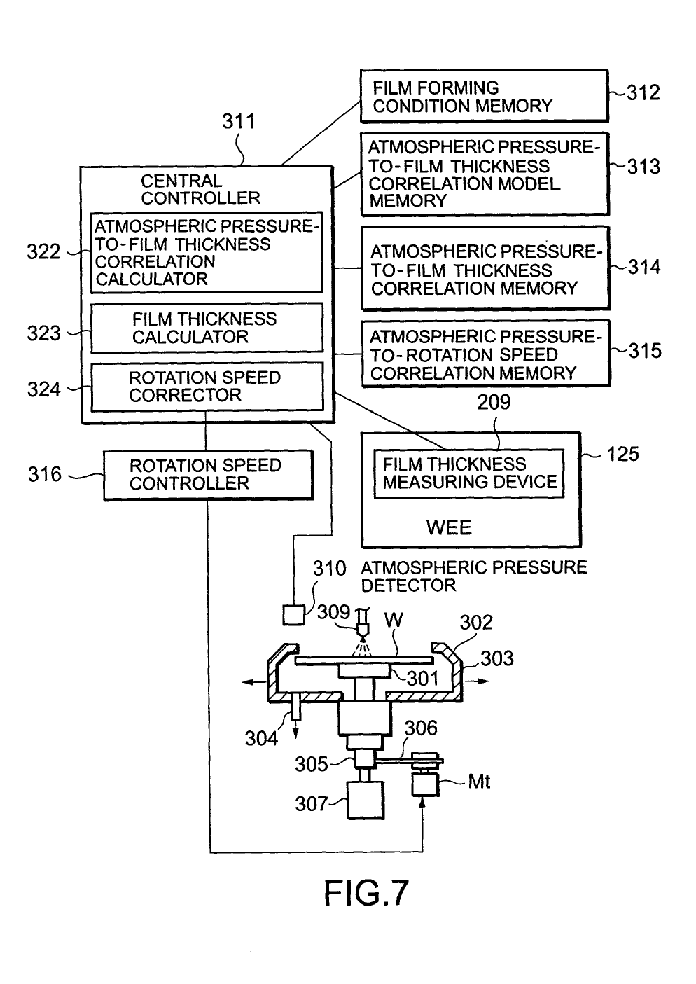

Next, the configurations of the resist coating unit (COT) including the atmospheric pressure meter and a control system according to the present invention will be explained with reference to FIG. 7.

First, a processing section will be explained. In FIG. 7, the numeral 301 denotes a spin chuck as a substrate holder which is structured to horizontally hold the wafer W by vacuum suction. A fixed cup 302 is provided to surround the spin chuck 301. An exhaust port 303 and a drainage port 304 are formed in a side face and a bottom face of the fixed cup 302 respectively. An opening in the upper face of the fixed cup 302 is opened during the coating of the resist solution.

The spin chuck 301 is provided at the top of a driving shaft 305, for example, in which a rotating shaft and a raising and lowering shaft are coaxially combined, and this driving shaft 305 is structured to be rotatable by a motor M1 via a transmitting mechanism 306 including a pulley and a belt and to be ascendable and descendable by a raising and lowering mechanism 307.

A resist solution nozzle 309 which supplies the resist solution while dropping it to a central portion of the wafer W held by the spin chuck 301 is provided on the upper side of the fixed cup 302. This nozzle 309 is structured to be movable between a position above the central portion of the wafer W and the outside of the side face of the fixed cup 302 by means of an arm not illustrated. Also, the resist solution nozzle 309 is connected to a resist solution tank not illustrated via a resist solution supply pipe not illustrated, and discharges a predetermined amount of resist solution, for example, by increasing the pressure inside the resist solution tank.

Next, a detection/control system will be explained. This resist coating unit (COT) includes the atmospheric pressure detector 310. This detector 310 may be provided inside a casing or outside the casing, when the processing section is housed in the casing and comprises a coating unit.

When the detector 301 is provided inside the casing, for example, it is possible to close the system. When a barometer is provided in an adjoining stepper, the barometer may be utilized.

An atmospheric pressure value detected by the atmospheric pressure detector 310 is inputted to a central controller 311 for controlling the entire system including this coating unit. If only configurations related to the gist of the present invention are described, a film forming condition memory 312 which stores resist solution film forming conditions, an atmospheric pressure-to-film thickness correlation model memory 313 (correlation model storage), an atmospheric pressure-to-film thickness correlation memory 314 (a first memory), a film thickness-to-rotation speed correlation memory 315 (a second memory), the film thickness measuring device 209 provided in the peripheral edge exposure unit 125 (WEE), and a rotation speed controller 316 which controls the motor M1 are connected to the controller 311.

Their configurations will be explained in detail based on their functions.

The film forming conditions stored in the film forming condition memory 312 include at least a target film thickness M0 of a coating film in each product, an initialized rotation speed K0 of the spin chuck 301, and an updated (corrected) rotation speed K1 of the spin chuck 301.

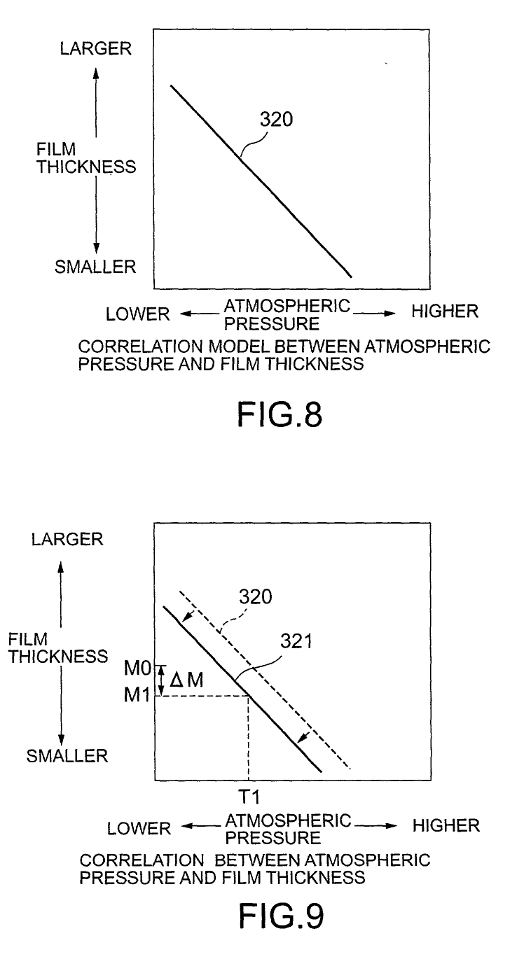

As shown in FIG. 8, the correlation model stored in the atmospheric pressure-to-film thickness correlation model memory 313 is specifically indicated by a line 320 (a straight line in this example) shown by a full line where the horizontal axis is atmospheric pressure and the vertical axis is film thickness. The line 320 shows a general correlation between atmospheric pressure and film thickness.

The relation between atmospheric pressure and coating film thickness will be explained now. Generally, there is a correlation in which with an increase in atmospheric pressure, the evaporation rate rises, resulting in a reduction in resist solution film thickness. In this embodiment, by applying a film thickness and an atmospheric pressure which are actually measured to this correlation model, a correlation between atmospheric pressure and film thickness in this condition is obtained. Specifically, as shown in FIG. 9, when an atmospheric pressure and a film thickness in actual measurement are T1 and M1 respectively, the line 320 is corrected to a line 321. This line 321 is stored in the atmospheric pressure-to-film thickness correlation memory 314 as the correlation between atmospheric pressure and film thickness in this condition. This calculation is performed by an atmospheric pressure-to-film thickness calculator 322 provided in the central controller 311 (FIG. 7).

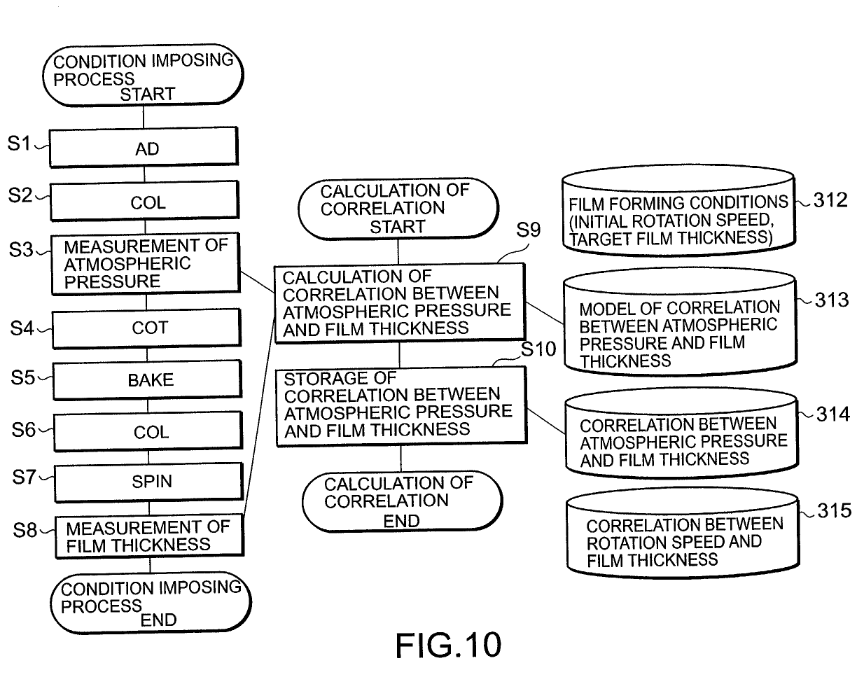

Incidentally, the calculation of the correlation between atmospheric pressure and film thickness is performed by the use of the wafer W for imposing conditions. Accordingly, a condition imposing process for this wafer for imposing conditions will be explained with reference to FIG. 10.

First, the wafer W is subjected to hydrophobic processing by the adhesion processing unit (AD) (step S1). Thereafter, the wafer W subjected to the hydrophobic processing is cooled by the cooing processing unit (COL) (step S2). When the wafer W is then inserted into the resist coating unit (COT), an atmospheric pressure is detected by the atmospheric pressure detector 310 (step S3) and the resist solution is applied onto the wafer W subjected to the cooling processing (step S4).

Subsequently, the wafer W on which a resist film is formed is subjected to heating processing by the pre-baking unit (PREBAKE) (step S5), and then subjected to cooling processing by the cooling processing unit (COL) (step S6).

Thereafter, the wafer W is mounted on the spin chuck 204 inside the peripheral edge exposure unit 125 by means of the wafer carrier 126, the wafer W is positioned by the X-Y stage 202 and the rotating mechanism 203 while the position of the wafer W is detected by the sensor 208, and the wafer W is subjected to peripheral edge exposure (step S7). Then, the film thickness measuring device 209 measures a thickness of the film on the wafer W while the wafer carrier 126 receives the wafer W from above the spin chuck 204 and carries it to the outside of the casing 201 through the opening 205 (step S8).

Next, in steps S9 and S10, a correlation between atmospheric pressure and film thickness is derived based on the atmospheric pressure and film thickness measured in the aforesaid steps, and stored in the atmospheric pressure-to-film thickness correlation memory 314.

Namely, the correlation between atmospheric pressure and film thickness is first calculated in step S9. More specifically, as described above, the actual correlation 321 is derived as shown in FIG. 9 by applying the atmospheric pressure measured value T1 and the film thickness measured value M1 to the correlation model 320 shown in FIG. 8. The correlation 321 thus derived is stored in the atmospheric pressure-to-film thickness correlation memory 314 in step S10.

Incidentally, the above condition imposing process is performed during an actual production fabricating process which will be explained below, and the above condition imposing process may be performed, for example, every predetermined hours in the actual product fabricating process, the above condition imposing process may be performed every time a predetermined number of wafers are processed in the actual product fabricating process, or the above condition imposing process may be performed when an atmospheric pressure is outside a set range in the actual product fabricating process. The aforesaid performance of the condition imposing process in predetermined timing enables more precise control of film thickness. Moreover, the flow of the wafer may be constructed with the condition imposing process and the actual product fabricating process in parallel with each other (The processes are performed almost concurrently in the same unit), and thereby data obtained in the condition imposing process is reflected in the product fabricating process in real time or every several wafers. Meanwhile, when data on the correlation between atmospheric pressure and film thickness are already possessed, these data may be directly inputted to this system. Thereby, the condition imposing process can be omitted.

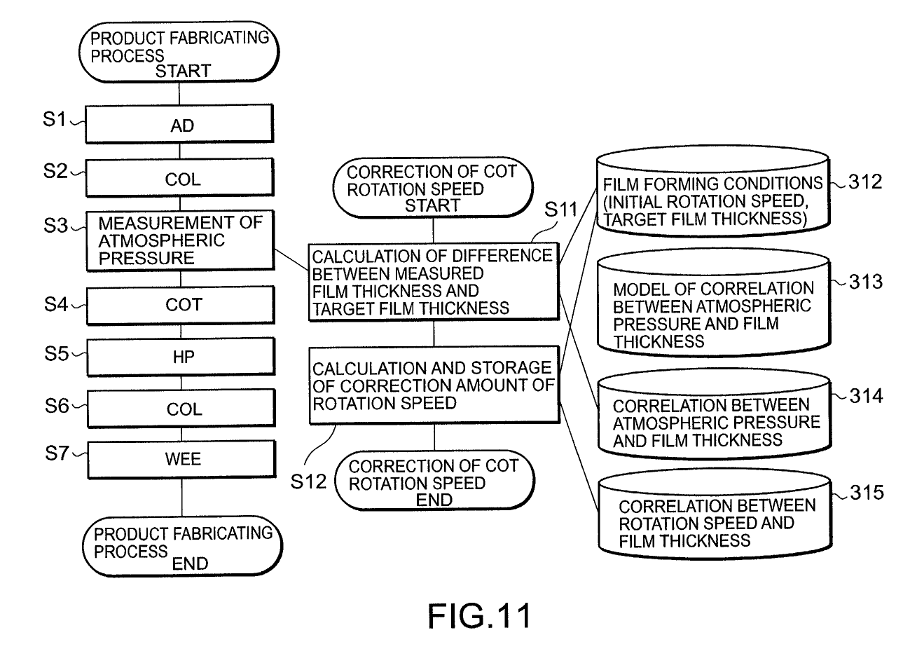

Next, the actual product fabricating process to be performed after such a condition imposing process will be explained with reference to FIG. 11.

The product fabricating process is basically the same as the condition imposing process, but the film thickness measuring step (step S8) shown in FIG. 9 is not performed. Moreover, in this product fabrication, in the atmospheric pressure measuring step S3, an atmospheric pressure inside the resist coating unit (COT) is detected, the rotation speed is corrected based on this atmospheric pressure by a rotation speed corrector in the central controller 311, and thereafter coating of the resist solution is performed in step S4.

Assuming that a detected value of the atmospheric pressure is T1, for example, a difference between a measured film thickness and a target film thickness is calculated based on this value in step S11. Specifically, a film thickness calculator 323 provided in the central controller 311 applies this T1 to the aforesaid correlation as shown in FIG. 9 to derive the film thickness M1 on this occasion. Subsequently, a target film thickness M0 is taken out from the film forming condition memory 312, and a difference ΔM between this target film thickness M0 and the film thickness detected value M1 is derived.

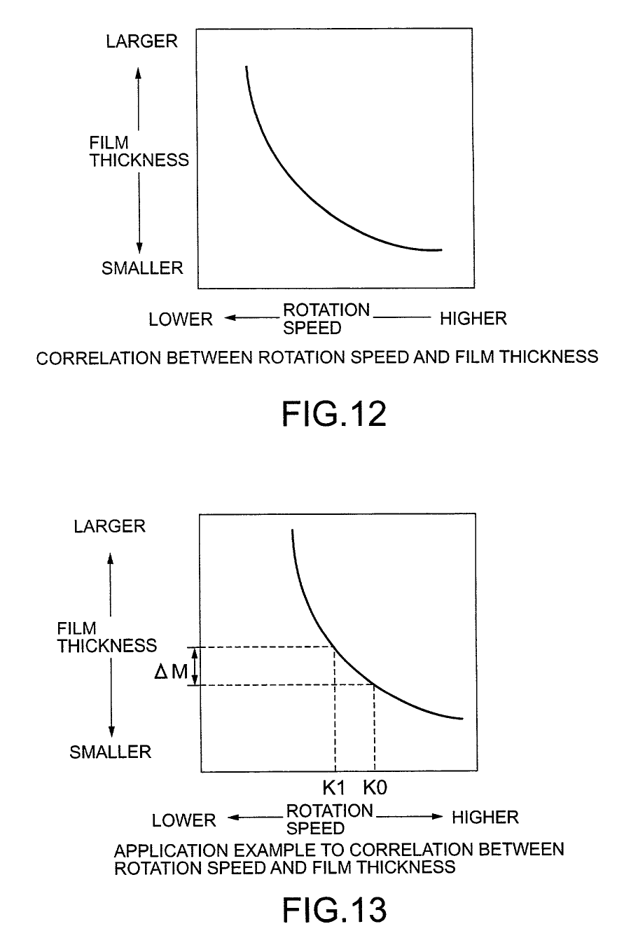

Subsequently, in step S12, the difference ΔM in film thickness is applied to the correlation between film thickness and rotation speed stored in the film thickness-to-rotation speed correlation memory 315 and a correction rotation speed (amount) is calculated by a rotation speed corrector 324 provided in the central control unit 211. FIG. 12 shows an example of this correlation.

Accordingly, concerning the correction amount of the rotation speed, a corrected rotation speed K0 is as shown in FIG. 13 when an initialized rotation speed stored in the film forming condition memory 312 is K1 (rmp). This corrected rotation speed is stored in the film forming condition memory 312.

Subsequently, in the aforesaid coating step S4, the spin chuck is rotationally driven at this corrected rotation speed K1, and the resist film is formed on the wafer.

The following effects can be obtained by the configurations explained above.

Firstly, variations in film thickness due to variations in atmospheric pressure are eliminated, whereby film thickness can be controlled with high precision.

Namely, the present invention is based on new knowledge of inventors that the reason why the thickness of a coating film is not stable in spite of various settings is that the evaporation rate of a solvent or the like contained in the coating film is not stable under the influence of atmospheric pressure. According to the present invention, a film thickness in atmospheric pressure is measured, and the rotation speed of a substrate is controlled so as to eliminate a difference between this film thickness and a target film thickness, resulting in very precise film thickness control.

Secondly, in this embodiment, an atmospheric pressure is once converted into a film thickness, and a correction rotation speed is derived based on a difference between this film thickness and the target film thickness. In other words, although there is a method in which a correlation between atmospheric pressure and rotation speed is previously found and in which atmospheric pressure is directly converted into a rotation speed as another example of a way of thinking in the correction of rotation speed based on atmospheric pressure, this method needs vast experimentation and tests and thus it is not practicable. Contrary to this, in the present invention, a difference in film thickness is obtained based on a measured value of atmospheric pressure, and the rotation speed is adjusted so as to make up for this difference in film thickness, whereby the aforesaid tests become unnecessary.

Moreover, generally, the relation between rotation speed and film thickness has a liner relation irrespective of atmospheric pressure. Hence, the aforesaid conversion can be performed easily at a high speed, whereby throughput is not lowered even if calculation is performed during processing.

It should be mentioned the present invention is not limited to the aforesaid embodiment and it can be modified variously without departing from the spirit of the present invention.

For example, the shapes of lines showing the correlation between atmospheric pressure and film thickness and the correlation between rotation speed and film thickness are not limited to those in the aforesaid embodiment. For example, the relation between rotation speed and film thickness is not limited to that shown in FIG. 12, and, for example, the relation of rotation speed to film thickness may be fixed irrespective of variations in atmospheric pressure.

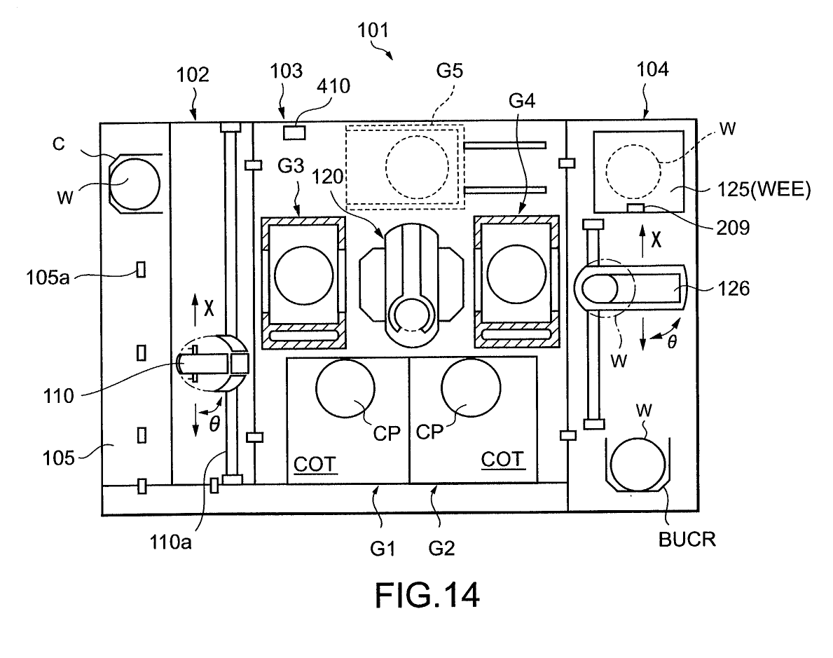

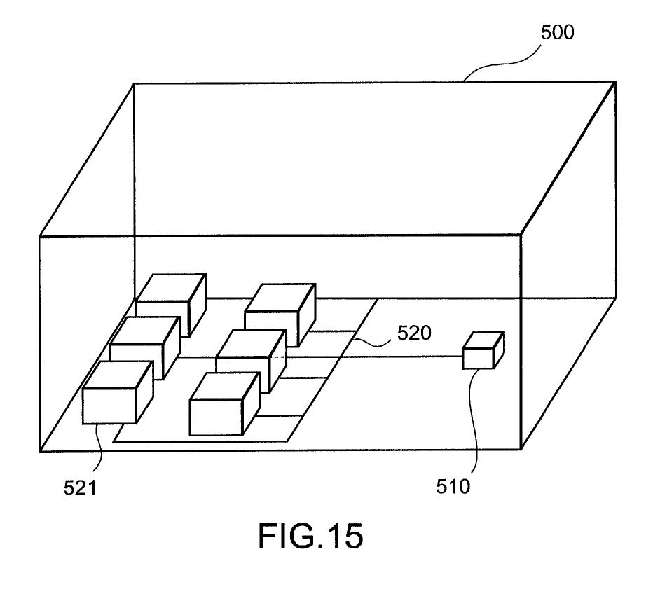

Although the atmospheric pressure meter 310 is disposed in the resist coating unit (COT) in the aforesaid embodiment, an atmospheric pressure meter 410 may be disposed in an area other than the resist coating unit (COT), for example, in an unoccupied space on the rear side of the processing station 103 as shown in FIG. 14. Further, the atmospheric pressure meter may be disposed outside this coating and developing processing system. For example, when a plurality of coating and developing processing systems 101 are arranged inside a clean room 500 as shown in FIG. 15, one atmospheric pressure meter 510 is disposed in a predetermined position, for example, adjacent to a signal tower, inside the clean room 500. These plurality of coating and developing processing systems 101 may have measurement data by the one atmospheric pressure meter 510 in common, for example, via a network 520. Thus, the number of atmospheric pressure meters can be decreased, whereby maintenance is greatly facilitated in addition to a reduction in cost.

Furthermore, the aforesaid embodiment is explained with the wafer as an example of a substrate, but the substrate may be a glass substrate for a liquid crystal display without limiting to the above example.

As described above, according to the present invention, film thickness can be controlled with high precision regardless of variations in atmospheric pressure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A coating film forming apparatus for forming a coating film on a substrate, comprising:
a rotating unit which rotates the substrate;
a coating solution supplying unit which supplies a coating solution to the substrate rotated by said rotating unit;
a memory which stores a first correlation between an atmospheric pressure and a film thickness of the coating film formed on the substrate, and a second correlation between a film thickness and a rotation speed of said substrate;
a target film thickness unit which generates a target film thickness of a coating film;
an atmospheric pressure detector which detects an actual atmospheric pressure;
a film thickness computation unit which computes an actual film thickness of the coating film from the actual atmospheric pressure detected by said atmospheric pressure detector based on the first correlation stored in said memory; and
a rotation speed control unit which obtains a corrected rotation speed of said substrate based on the second correlation stored in said memory and a difference between the actual film thickness computed by said film thickness computation unit and the target film thickness, and controls said rotating unit to rotate said substrate at the corrected rotation speed.

2. The apparatus according to claim 1, wherein said memory stores the first correlation determined by an increase in atmospheric pressure and a reduction in resist solution film thickness according to the increase in atmospheric pressure.

3. A coating film forming apparatus for forming a coating film on a substrate, comprising:
a substrate holder which holds the substrate;
a rotating unit which rotates said substrate holder;
a coating solution supplying unit which supplies a coating solution to the substrate while rotating the substrate to spread the coating solution by a centrifugal force due to the rotation;
a first memory which stores a first correlation between an atmospheric pressure and a film thickness of the coating film formed on the substrate;
a second memory which stores a second correlation between a film thickness and a rotation speed of said substrate holder;
a third memory which stores at least a target film thickness of a coating film;
an atmospheric pressure detector which detects an actual atmospheric pressure;
a film thickness computation unit which computes an actual film thickness of the coating film from the actual atmospheric pressure detected by said atmospheric pressure detector based on the correlation stored in said first memory;
a rotation speed computation unit which computes a corrected rotation speed of said substrate holder from a difference between the actual film thickness computed by said film thickness computation unit and the target film thickness read out from said third memory, based on the correlation stored in said second memory; and
a speed controller which controls said rotating unit to rotate said substrate holder at the corrected rotation speed.

4. The apparatus according to claim 3, further comprising:
a film thickness detector which detects an actual film thickness of a coating film formed on a substrate for imposing conditions; and
a correlation unit which derives a correlation between an atmospheric pressure and a film thickness from the actual film thickness and an atmospheric pressure at that time, and stores the correlation as the first correlation in said first memory.

5. The apparatus according to claim 3, further comprising:
a correlation model storage which stores a model of the correlation between the atmospheric pressure and the film thickness,
said correlation unit obtaining the correlation between the atmospheric pressure and the film thickness by applying the actual film thickness detected by said film thickness detector and an atmospheric pressure at that time to the model of correlation.

6. The apparatus according to claim 5, wherein said atmospheric pressure detector is disposed outside said coating film forming apparatus.

7. The apparatus according to claim 3, wherein said first memory stores the first correlation determined by an increase in atmospheric pressure and a reduction in resist solution film thickness according to the increase in atmospheric pressure.

8. The apparatus according to claim 3, wherein said third memory stores the corrected rotation speed.

9. A coating film forming method for forming a coating film on a substrate, comprising:
rotating the substrate;
supplying a coating solution to the rotating substrate;
storing a first correlation between an atmospheric pressure and a film thickness of the coating film formed on the substrate and a second correlation between a film thickness and a rotation speed of said substrate in a memory;
generating a target film thickness of a coating film;
detecting an actual atmospheric pressure;
computing an actual film thickness of the coating film from the actual atmospheric pressure detected in said atmospheric pressure detecting step based on the first correlation stored in said memory; and
obtaining a corrected rotation speed of said substrate based on the second correlation stored in said memory and a difference between the actual film thickness computed in said computing step and the target film thickness; and
rotating said substrate at the corrected rotation speed.

10. The method according to claim 9, wherein said memory stores the first correlation determined by an increase in atmospheric pressure and a reduction in resist solution film thickness according to the increase in atmospheric pressure.

11. A coating film forming method for forming a coating film on a substrate, comprising:
rotating the substrate;
supplying a coating solution to the rotating substrate to spread the coating solution by a centrifugal force due to the rotation of the substrate;
storing a first correlation between an atmospheric pressure and a film thickness of a coating film formed on the substrate in a first memory;
storing a second correlation between the film thickness and a rotation speed of the substrate in a second memory;
detecting an actual atmospheric pressure;
calculating an actual film thickness of the coating film from the detected actual atmospheric pressure based on the first correlation stored in the first memory;
calculating a correction rotation speed of the substrate based on the second correlation stored in the second memory and a difference between the calculated actual film thickness and a target film thickness; and
correcting the rotation speed of the substrate to the calculated correction rotation speed.

12. The method according to claim 11, wherein the step of storing a first correlation obtains the first correlation using a substrate for imposing conditions in a condition imposing process before a product fabricating process.

13. The method according to claim 12, wherein the condition imposing process is performed every predetermined hours in the product fabricating process.

14. The method according to claim 12, wherein the condition imposing process is performed every time a predetermined number of wafers are processed in the product fabricating process.

15. The method according to claim 12, wherein the condition imposing process is performed when the detected actual atmospheric pressure is outside a predetermined range.

16. The method according to claim 12, wherein the step of storing a first correlation is performed by inputting data on the first correlation previously obtained.

17. The method according to claim 11, wherein said step of storing a first correlation stores in the first memory the first correlation determined by an increase in atmospheric pressure and a reduction in resist solution film thickness according to the increase in atmospheric pressure.
